(19) United States
(12) Patent Application Publication
(10) Pub. No.: US 2009/0183606 A1
(43) Pub. Date: Jul. 23, 2009

(54) ASSEMBLY ELEMENT OF A HAND TOOL

(76) Inventor: Teng Yuan Kuo, Taichung (TW)

Correspondence Address: TROXELL LAW OFFICE PLLC, 5205 LEESBURG PIKE, SUITE 1404, FALLS CHURCH, VA, 22041, US

(21) Appl. No.: 12/015,517

(22) Filed: Jan. 17, 2008

(51) Int. Cl. B25B 13/02

(52) U.S. Cl. 81/125

(57) ABSTRACT

An assembly element including accessories of force-applying hand tools (screwdrivers, wrenches, ratchets, etc.) such as a socket, a connecting bar, an adapter, a universal joint, a compression socket, etc. A polygonal portion (quadrangular, hexagonal, octagonal, etc.) is formed at the largest part of the accessories. An antislip portion is interposed between every two adjacent sides of the polygonal portion for avoiding an undesired rolling as well as for achieving an easy grip and a rapid tightening. More than one annular groove is formed in the polygonal portion of the above-mentioned accessories. The annular groove can be filled with a colored paint as an identification label for an easy identification of the item number, size, type, etc.

### BACKGROUND OF THE INVENTION

1. Fields of the Invention

The invention relates to an assembly element of a hand tool, and more particularly, to a structure for avoiding an undesired rolling as well as for achieving an easy grip and a rapid tightening. Moreover, it serves as an identification label for an easy identification of the item number, size, type, etc.

2. Description of the Related Art

The assembly element of a hand tool includes accessories of force-applying hand tools (screwdrivers, wrenches, ratchets, etc.) such as a socket, a connecting bar, an adapter, a universal joint, a compression socket, etc. By connecting both of them to each other, the screws can be tightened. In considering an easy and economical production, all of the existing assembly elements include a smooth cylindrical body at the largest part thereof. That is, the part held by the operator is formed as a smooth cylindrical body.

The above-mentioned structure has been adopted for decades, and the operators are also accustomed thereto. However, this part is formed as a cylindrical body that causes an undesired rolling displacement when it lies on a surface. Therefore, the operator has to pay attention to its position. Even, its search requires the attention of the operator, thereby causing much inconvenience and delay of the work. Moreover, the fingers of the operator can be greasy when working under an oily operation environment so that the operator cannot hold the assembly element with a smooth surface properly. As a result, an unexpected slip often takes place. Meanwhile, the operator cannot perform a rapid tightening process with his fingers. Thus, the conventional structure requires further improvements.

### SUMMARY OF THE INVENTION

A first object of the invention is to provide an assembly element of a hand tool and to change the form and the structure of the largest part of the assembly element such that the above-mentioned drawbacks of the conventional products can be eliminated while the convenience and the practicalness of the invention are ensured.

A second object of the invention is to provide an assembly element of a hand tool that includes more than one annular groove formed in the largest portion thereof as an identification label for an easy identification of the item number, size, type, etc.

According to the invention, an assembly element of a hand tool includes a polygonal portion (quadrangular, hexagonal, octagonal, etc.) at the largest part thereof. An antislip portion is interposed between every two adjacent sides of the polygonal portion for avoiding an undesired rolling as well as for achieving an easy grip and a rapid tightening.

### BRIEF DESCRIPTION OF THE DRAWINGS

The accomplishment of this and other objects of the invention will become apparent from the following description and its accompanying drawings of which:

FIG. 1 is a perspective view of a first embodiment of the invention;

FIG. 2 is a side view of the first embodiment of the invention according to FIG. 1;

FIG. 3 is a perspective view of a second embodiment of the invention;

FIG. 4 is a perspective view of a third embodiment of the invention;

FIG. 5 is a perspective view of a fourth embodiment of the invention;

FIG. 6 is a perspective view of a fifth embodiment of the invention;

FIG. 7 is a perspective view of a sixth embodiment of the invention; and

FIG. 8 is a perspective view of a seventh embodiment of the invention.

### DETAILED DESCRIPTION OF THE PREFERRED EMBODIMENT

The present invention will now be described in more detail hereinafter with reference to the accompanying drawings that show various embodiments of the invention.

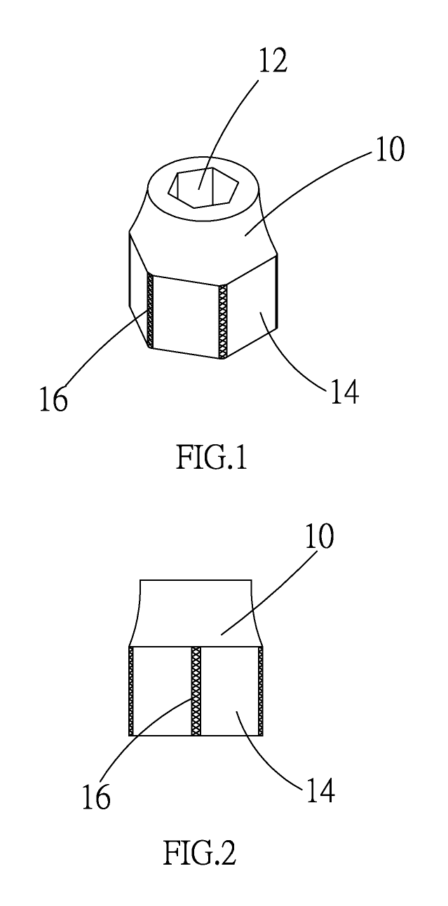

Referring to FIGS. 1 and 2, an assembly element in accordance with a first embodiment of the invention is a socket 10 having a tool insertion hole 12 at one end thereof and a slot (not shown) at the other end thereof. A polygonal portion 14 is formed at the largest part of the socket 10. An antislip portion 16 is interposed between every two adjacent sides of the polygonal portion 14 for achieving a prearranged effect.

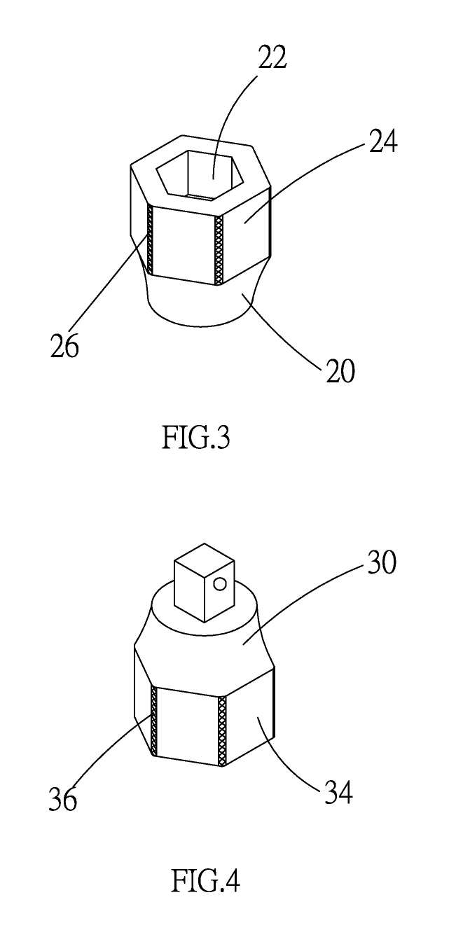

Referring to FIG. 3, which illustrates a second embodiment of the invention, the assembly element is another socket 20. Likewise, the socket 20 includes a tool insertion hole 22 at one end thereof and a slot (not shown) at the other end thereof. A polygonal portion 24 is formed at the largest part of the socket 20. An antislip portion 26 is interposed between every two adjacent sides of the polygonal portion 24.

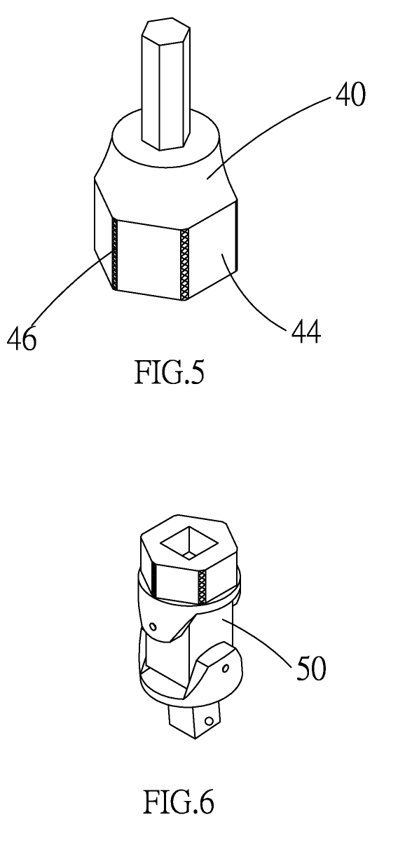

Referring to FIGS. 4 and 5, which illustrate a third and a fourth embodiment of the invention, the assembly element is an adapter 30 and a compression socket 40. Likewise, a polygonal portion 34, 44 is formed at the largest part of the adapter 30 and the compression socket 40. An antislip portion 36, 46 is interposed between every two adjacent sides of the polygonal portion 34, 44.

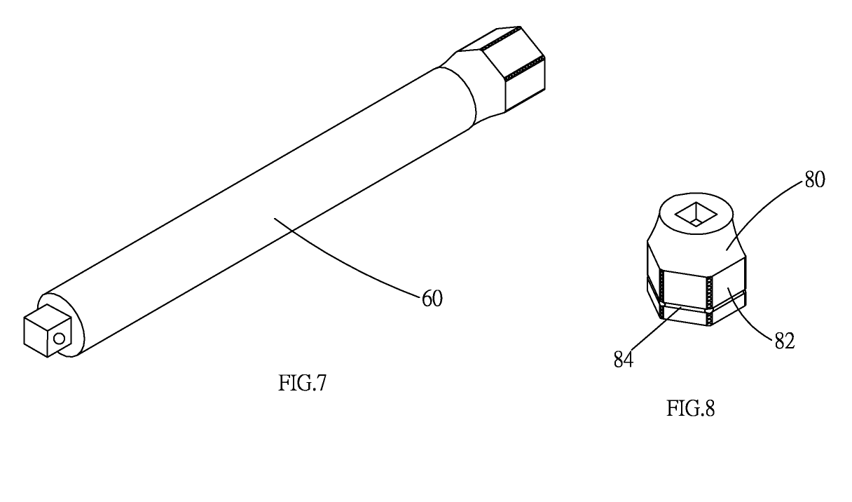

Referring to FIGS. 6 and 7, which illustrate a fifth and a sixth embodiment of the invention, the assembly element is a universal joint 50 and an extension bar 60 that also include the features of the invention.

Referring to FIG. 8, more than one annular groove 84 is formed in the polygonal portion 82 of the above-mentioned socket 80. The annular groove 84 can be filled with a colored paint as an identification label for an easy identification of the item number, size, type, etc.

The assembly element of the invention has a wide application scope and includes almost all of the assembly elements of hand tools. It is difficult to show all of them with drawings. As a result, any elements that are added or equivalent to the invention should fall within the scope of the invention.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

1. An assembly element of a hand tool including accessories of force-applying hand tools, comprising:
a polygonal portion being formed at the largest part of the hand tool, an antislip portion being interposed between every two adjacent sides of the polygonal portion, the antislip portions being flush with the two adjacent sides of the polygonal portion.

2. The assembly element as recited in claim 1, wherein more than one annular groove is formed in the polygonal portion.
